(19) United States
(12) Patent Application Publication
(10) Pub. No.: US 2007/0001065 A1
(43) Pub. Date: Jan. 4, 2007

(54) Computer keyboard wrist pad

(76) Inventor: Jack Lo, Pacifica, CA (US)

Correspondence Address: JACK LO, 617 VIEWRIDGE DRIVE, PACIFICA, CA, 94044, US

(21) Appl. No.: 11/156,438

(22) Filed: Jun. 20, 2005

(51) Int. Cl. B68G 5/00

(52) U.S. Cl. 248/118

(57) ABSTRACT

A computer keyboard wrist pad is comprised of right and left ulnar support surfaces, and right and left wrist support surfaces respectively angled up from the inner sides of the ulnar support surfaces. The wrist support surfaces are angled toward each other in a bottom-to-top direction, and also angled toward each other in a front-to-back direction. Right and left thumb pad support surfaces are respectively angled up from the right and left ulnar support surfaces forward of the wrist support surfaces. The thumb pad support surfaces are angled toward each other more sharply than the wrist support surfaces. An intermediate portion of a front edge of the wrist pad is generally level with the ulnar support surfaces. A forwardly extending concavity is positioned between the wrist support surfaces.

### BACKGROUND OF THE INVENTION

1. Field of the Invention

The invention broadly relates to computer wrist pads and supports.

2. Prior Art

A computer keyboard wrist pad is for positioning in front of a keyboard to lift the wrists higher for reaching the keys easier, and for providing a soft resting surface. The wrist pad is typically comprised of an elongated bar of foam or gel covered with a fabric. The pad has a uniformly shaped top surface which is flat or slightly curved about a transverse axis. It provides no more ergonomic benefit than merely a soft supporting surface. Since the top of the pad is generally flat, the wrists are placed flat on the support so that the palms of hands are parallel to the keyboard surface. The forearms are thus substantially twisted from their neutral positions wherein the hands are in a handshake position. It is widely known that many users experience wrist discomfort and pain after long term use of flat keyboards. Some users even become severely injured.

### BRIEF SUMMARY OF THE INVENTION

A primary object of the invention is to support the wrists with reduced forearm twisting from the neutral position.

Another object is to lift the wrists higher for reaching the keys of a keyboard easier.

Another object is to avoid interfering with thumb movements when typing.

Another object is to improve comfort even when using a flat keyboard.

Another object is to minimize the amount of material for making the support.

The present computer keyboard wrist pad is comprised of right and left ulnar support surfaces, and right and left wrist support surfaces respectively angled upward from the inner sides of the ulnar support surfaces. The wrist support surfaces are angled toward each other in a bottom-to-top direction, and also angled toward each other in a front-to-back direction. Right and left thumb pad support surfaces are respectively angled upward from the right and left ulnar support surfaces forward of the wrist support surfaces. The thumb pad support surfaces are angled toward each other more sharply than the wrist support surfaces. An intermediate portion of a front edge of the wrist pad is generally level with the ulnar support surfaces. A forwardly extending concavity is positioned between the wrist support surfaces.

### BRIEF DESCRIPTION OF THE SEVERAL VIEWS OF THE DRAWING

FIG. 1 is a top perspective view of the computer keyboard wrist pad.

FIG. 2 is a top view thereof.

FIG. 3 is a front view thereof.

FIG. 4 is a rear view thereof.

FIG. 5 is a right side view thereof.

FIG. 6 is a left side view thereof.

FIG. 7 is a front perspective view thereof positioned in front of a keyboard.

FIG. 8 is a front perspective view thereof supporting a pair of hands over the keyboard.

### DETAILED DESCRIPTION OF THE INVENTION

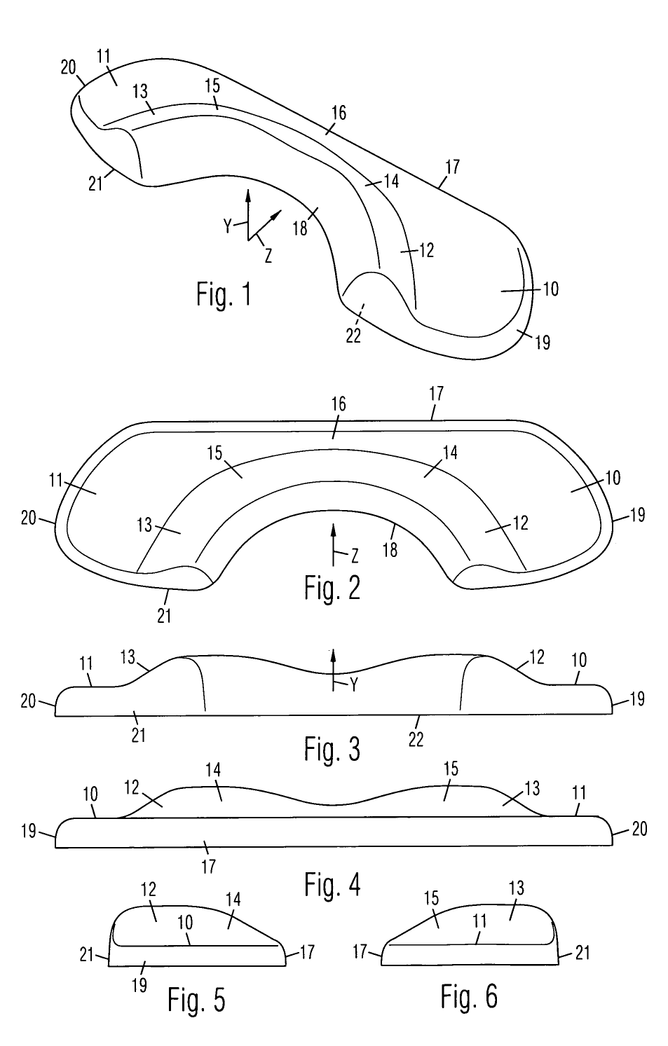

FIGS. 1-6

A preferred embodiment of a computer keyboard wrist pad is shown in a top perspective view in FIG. 1, a top view in FIG. 2, a front view in FIG. 3, a rear view in FIG. 4, a right view in FIG. 5, and a left view in FIG. 6. It is comprised of right ulnar support surface 10 and left ulnar support surface 11 for respectively supporting the right and left ulnar sides (little finger side) of the right and left hands and forearms for reaching the keys of a keyboard. Although ulnar support surfaces 10 and 11 are shown as flat surfaces, they may be contoured for more closely cradling the wrists and hands.

Right wrist support surface 12 and left wrist support surface 13 are respectively angled upward from the inner sides of ulnar support surfaces 10 and 11 at about 25 degrees from horizontal for supporting the right and left wrists, although other angles are possible. Wrist support surfaces 12 and 13 are angled toward each other in a bottom-to-top direction Y for supporting the wrists in angled positions for reducing forearm twisting. Wrist support surfaces 12 and 13 are also angled toward each other in a front-to-back direction Z for supporting the forearms angled toward each other so that the hands are close together for typing.

Right thumb pad support surface 14 and left thumb pad support surface 15 are respectively angled upward from the inner sides of ulnar support surfaces 10 and 11, forward of wrist support surfaces 12 and 13 for supporting the right and left thumb pads (the fleshy part of the hand covering the metacarpal bone of the thumb). Thumb pad support surfaces 14 and 15 are angled toward each other in direction Y, and angled toward each other in direction Z. Thumb pad support surfaces 14 and 15 are angled toward each other more sharply than wrist support surfaces 12 and 13 to avoid interfering with thumb movement during typing.

An intermediate portion 16 at a rear edge 17 of the wrist pad is lower than wrist support surfaces 12 and 13 and generally level with ulnar support surfaces 10 and 11 to avoid interfering with thumb movement during typing. A forwardly extending concavity 18 between wrist support surfaces 12 and 13 reduces the amount of material for making the wrist pad.

The wrist pad includes a right end 19, a left end 20, a front edge 21, and a bottom surface 22. The wrist pad is comprised of a fabric covering on a resilient core such as open cell foam, silicon gel, memory foam, etc.

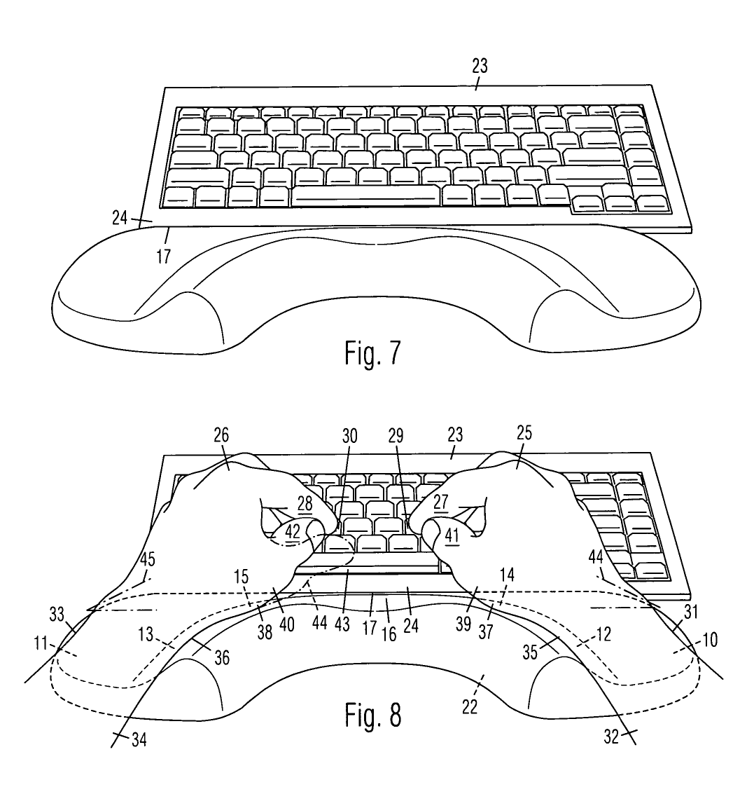

FIGS. 7-8

The wrist pad is shown in FIG. 7 in front of a computer keyboard 23 with rear edge 17 abutting a front edge 24 of keyboard 23. In FIG. 8, a right hand 25 and a left hand 26 are respectively positioned with the right and left index fingers 27 and 28 on a “J” key 29 and a “F” key 30.

An ulnar side 31 of a right forearm 32 and an ulnar side (not shown) at the proximal end of right hand 25 are supported on right ulnar support surface 10. An ulnar side 33 of a left forearm 34 and an ulnar side (not shown) at the proximal end of left hand 26 are supported on left ulnar support surface 11. The hands are thus lifted for reaching the keys easier. A right wrist 35 is positioned against right wrist support surface 12, and a left wrist 36 is positioned on left wrist support surface 13. A right thumb pad 37 is positioned on right thumb pad support surface 14 and a left thumb pad 38 is positioned on left thumb pad support surface 15.

Wrist support surfaces 12 and 13 are angled to respectively support wrists 35 and 36 at acute angles 44 and 45 relative to horizontal, preferably about 25 degrees, although other angles are possible. As a result, forearm twisting is reduced and comfort is increased even when using a flat keyboard. The angles are preferably both about 25 degrees, but other angles are possible. Wrist support surfaces 12 and 13 are also angled to respectively support forearms 32 and 34 angled toward each other for resting the fingers on the home keys.

Thumb pad support surfaces 14 and 15 are angled toward each other more sharply than wrist support surfaces 12 and 13 to avoid interfering with right and left phalanges 39 and 40 of thumbs 41 and 42 when either thumb presses space bar 43, as shown by dashed thumb 44. Further, intermediate portion 16 is generally level with ulnar support surfaces 10 and 11 to avoid interfering with right and left phalanges 39 and 40 when either thumb presses space bar 43.

Although the foregoing description is specific, it should not be considered as a limitation on the scope of the invention, but only as an example of the preferred embodiment. Many variations are possible within the teachings of the invention. The left hand right portions of the wrist pad may be separate from each other. The various support surfaces may be assembled together from separate pieces. Therefore, the scope of the invention should be determined by the appended claims and their legal equivalents, not by the examples given.

I claim:

1. A computer keyboard wrist pad, comprising:
right and left ulnar support surfaces; and
right and left wrist support surfaces angling upward from respective inner sides of the ulnar support surfaces, wherein the wrist support surfaces are angled toward each other in a bottom-to-top direction.

2. The computer keyboard wrist pad of claim 1, wherein the wrist support surfaces are also angled toward each other in a front-to-back direction.

3. The computer keyboard wrist pad of claim 1, further including right and left thumb pad support surfaces respectively angling upward from the ulnar support surfaces forward of the wrist support surfaces, wherein the thumb pad support surfaces are angled toward each other more sharply than the wrist support surfaces;

4. The computer keyboard wrist pad of claim 1, further including an intermediate portion at a front edge of the wrist pad, wherein the intermediate portion is generally level with the ulnar support surfaces.

5. The computer keyboard wrist pad of claim 1, further including a forwardly extending concavity between the wrist support surfaces.

6. A computer keyboard wrist pad, comprising:
right and left ulnar support surfaces;
right and left wrist support surfaces angling upward from respective inner sides of the ulnar support surfaces, wherein the wrist support surfaces are angled toward each other in a bottom-to-top direction, and also angled toward each other in a front-to-back direction; and
right and left thumb pad support surfaces respectively angling upward from the ulnar support surfaces forward of the wrist support surfaces, wherein the thumb pad support surfaces are angled toward each other more sharply than the wrist support surfaces.

7. The computer keyboard wrist pad of claim 6, further including right and left thumb pad support surfaces respectively angling upward from the ulnar support surfaces forward of the wrist support surfaces, wherein the thumb pad support surfaces are angled toward each other more sharply than the wrist support surfaces;

8. The computer keyboard wrist pad of claim 6, further including an intermediate portion at a front edge of the wrist pad, wherein the intermediate portion is generally level with the ulnar support surfaces.

9. The computer keyboard wrist pad of claim 6, further including a forwardly extending concavity between the wrist support surfaces.

10. A computer keyboard wrist pad, comprising:
right and left ulnar support surfaces;
right and left wrist support surfaces angling upward from respective inner sides of the ulnar support surfaces, wherein the wrist support surfaces are angled toward each other in a bottom-to-top direction, and also angled toward each other in a front-to-back direction;
right and left thumb pad support surfaces respectively angling upward from the ulnar support surfaces forward of the wrist support surfaces, wherein the thumb pad support surfaces are angled toward each other more sharply than the wrist support surfaces;
an intermediate portion at a front edge of the wrist pad, wherein the intermediate portion is generally level with the ulnar support surfaces; and
a forwardly extending concavity between the wrist support surfaces.
